(19) United States
(12) Patent Application Publication
(10) Pub. No.: US 2009/0324035 A1
(43) Pub. Date: Dec. 31, 2009

(54) METHOD OF COMBINING BINARY CLUSTER MAPS INTO A SINGLE CLUSTER MAP

(75) Inventors: Mark Christof Wengler, Heidenheim an der Brenz (DE); Timo Paulus, Aachen (DE); Alexander Fischer, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/375,747

(22) PCT Filed: Jul. 17, 2007
(86) PCT No.: PCT/IB2007/052843

§ 371 Date: Jan. 30, 2009

(30) Foreign Application Priority Data
Aug. 2, 2006 (EP) 06118315.8

(51) Int. Cl. G06K 9/62; G06T 7/00

(52) U.S. Cl. 382/128; 382/225

(57) ABSTRACT

This invention relates to a method of combining multiple binary cluster maps into a single cluster map; where each respective binary cluster map represents characteristic information and the single cluster map represent the sum of the characteristic information. Initially, each respective binary cluster map is assigned with a reliability factor for indicating the reliability of the binary cluster map. These factor values are then used to determine a reliability vector comprising reliability factor elements, where each respective reliability factor element is associated to certain cluster map area in the single cluster map and indicates the reliability of cluster map are. In that way, the single cluster map can be viewed with respect to the reliability.

### FIELD OF THE INVENTION

The present invention relates to a method and a device for combining multiple binary cluster maps into a single cluster map, where each respective binary cluster map represents characteristic information and the single cluster map represents a combination of the characteristic information.

### BACKGROUND OF THE INVENTION

Various medical imaging systems allow the measurement of biological functional parameters, either directly or by suitable analysis of the measured data, such as pharmacokinetic modelling, see European patent application number EP04102015.7 “Data processing system for compartmental analysis”. For clinical applications the resulting functional images are often processed further, to obtain a cluster map, see L. Xing et al.: “Inverse planning for functional image-guided intensity modulated radiation therapy”, Phys. Med. Biol. 47, 3567, 2002. By clustering the quasi-continuous levels of the original parametric map are reduced to allow clearer display. Often clustering is done in a way which results in only two levels, e.g. two tissue states: normal and pathological tissue. Such a functional two-level cluster map (binary map) allows easy differentiation of the two kinds of tissue, and is commonly used for applications such as radio therapy planning (RTP), see L. Xing et al.: “Inverse planning for functional image-guided intensity modulated radiation therapy”, Phys. Med. Biol. 47, 3567, 2002.

Some biologically important parameters can be obtained by more than just one measurement or analysis method. One example is a hypoxia related parameter, which can be measured by Magnetic Resonance Blood Oxygen Level Dependent (MR-BOLD)-measurement, by pharmacokinetic analysis of suitable Position Emission Tomography (PET)-images or by Magnetic Resonance Chemical Exchange Dependent Saturation Transfer (MR-CEST)-measurement. The resulting functional maps usually differ from each other, and so do the binary cluster maps. This means that some binary cluster maps contain highly relevant information, whereas other cluster maps might include less relevant information. The measurement or analysis methods that are used must therefore be selected very carefully for attaining as good information as possible from the binary map.

There is however a need for a method that is capable of collecting information from multiple cluster maps into a single cluster map, and which further allows a physician to evaluate the confidence level of the single cluster map.

### BRIEF DESCRIPTION OF THE INVENTION

The object of the present invention is to provide a method and a device that combine information from multiple binary cluster maps that represent characteristic information into a single binary cluster map, so that a physician can evaluate in a very user friendly way and more accurately the confidence level of the single cluster map.

According to one aspect the present invention relates to a method of combining multiple binary cluster maps into a single cluster map, where each respective binary cluster map includes characteristic information and the single cluster map represents a combination of the characteristic information, the method comprising:

assigning each respective binary cluster map with a reliability factor for indicating the reliability of each respective binary cluster map,

utilizing the reliability factors as input parameters for a pre-defined combination rule for determining a reliability vector for the single cluster map, wherein the reliability vector comprises reliability factor elements, where each respective reliability factor element is associated to a certain cluster map area in the single cluster map and indicates the reliability of the cluster map area.

Accordingly, since the combining of the binary cluster maps would typically at least partly result in an overlap of the binary cluster maps, the different overlap areas are assigned with a reliability value given by the reliability factor elements. It follows that those areas where the associated reliability factor elements have high reliability are to be considered as highly relevant areas, whereas those where the reliability factor elements have low reliability are to be considered as less relevant areas. In that way, a physician can evaluate the reliability of the different areas in the single cluster map in a much more effective way for further processing in e.g. diagnosis and/or therapy in applications such as radio therapy planning.

In an embodiment, the step of assigning each respective binary cluster map with a reliability factor is performed manually. The confidence level of every initial cluster map is dependent on many factors that can only be evaluated by an experienced physician (or user, doctor, technician). Accordingly, an interactive way is provided to obtain the best possible combined cluster map.

In an embodiment, the step of assigning each respective binary cluster map with a reliability factor is performed automatically by comparing the multiple binary clusters with reference binary clusters having assigned reliability factors. The automatic procedure could be based on a library for certain applications/modalities. E.g., if the modalities are PET and CT, the PET tracer is FluoroDeoxyGlucose (FDG) and the application is lung cancer, one could look up the appropriate reliability factors from the library.

In an embodiment, the method further comprises:

assigning a threshold value for the reliability vector, and

utilizing the assigned threshold value as an input parameter for an updated single cluster map.

In that way, the threshold level in the fused cluster map may be changed so that e.g. only the reliability factors above the threshold value will participate in the fused cluster map.

In an embodiment, the step of assigning a threshold value for the reliability factor elements is performed manually. In that way, a user, e.g. a physician, doctor, technician, can interactively change the threshold level of the fused cluster map, i.e. remove those parts of the fused cluster map that have too low confidence levels.

In an embodiment, the step of assigning a threshold value for the reliability factor elements is performed automatically by comparing the multiple binary clusters with reference binary clusters having assigned threshold values. The automatic procedure could be based on a library for certain applications/modalities. E.g., if the modalities are PET and CT, the PET tracer is FDG and the application is lung cancer, one could look up the appropriate threshold value from the library.

In an embodiment, the pre-defined combination rule is defined by the equation:

R_{N,N-1, . . . , 1}R_{N}+(1−R_{N})R_{N-1, . . . , 1}

with Rⱼ as the reliability factor for binary cluster map j=1 . . . N, where N is the total number of initial binary cluster maps. Accordingly, if N=3 and R₁=0.6, R₂=0.8 and R₃=0.4, a reliability vector comprising seven elements is obtained, R₃₂₁, R₃₁, R₃₂, R₁₂, R₃, R₂ and R₁. For this example the vector will be: R=[0.952; 0.920; 0.880; 0.760; 0.800; 0.600; 0.400]. In the above mentioned embodiment, the threshold value could e.g. be selected as 0.8, in that way the combined cluster map includes only those cluster map areas that have reliability factor above/including the reliability value 0.8.

In an embodiment, different color information is associated to each respective binary cluster map, and wherein the reliability vector is displayed simultaneously with the combined cluster map with corresponding color information such that each vector element associated with the a given combined cluster map portion is displayed with the same color information. In that way, a user can very easily link the different colors in the vector element to the cluster map and in that way easily discover which areas of the single cluster map are the most relevant areas.

According to another aspect, the present invention relates to a computer program product for instructing a processing unit to execute the above method steps when the product is run on a computer.

According to still another aspect, the present invention relates to a device adapted to combine multiple binary cluster maps into a single cluster map, where each respective binary cluster map includes characteristic information and the single cluster map represents a combination of the characteristic information, comprising:

assigning means for assigning each respective binary cluster map with a reliability factor for indicating the reliability of each respective binary cluster map, and

a processor for utilizing the reliability factors as input parameters for a pre-defined combination rule for determining a reliability vector for the single cluster map, wherein the reliability vector comprises reliability factor elements, where each respective reliability factor element is associated to a certain cluster map area in the single cluster map and indicates the reliability of the cluster map area.

In an embodiment, the assigning means for assigning comprises an input means adapted to receive a manual input from a user or an algorithm adapted to automatically evaluate the reliability factor assigned to each respective binary cluster map. The input means can e.g. comprise a keyboard, a mouse, a speech recognition system and the like that is adapted to receive a command from a user for a reliability factor. In case the assigning means comprises the algorithm, the reliability factor can be selected automatically by the algorithm, e.g. by comparing the binary maps with pre-stored binary maps obtained with the same analysis method, where e.g. statistical evaluation determines the quality of the binary maps, or it could comprise a library of analysis methods and modalities with associated “average” reliability values, e.g. Lung nodule scan with CT: R=0.8, Lung nodule scan with FDG PET: R=0.85, etc.

The aspects of the present invention may each be combined with any of the other aspects. These and other aspects of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a flowchart of a method according to the present invention of fusing multiple binary cluster maps representing the same characteristic information into a single cluster map,

FIGS. 2a-c shows an example of three binary cluster maps,

FIG. 3 shows a single combined cluster map obtained from the binary cluster maps in FIGS. 2a-c,

FIGS. 4-6 depict an embodiment where a threshold value is assigned for the reliability vector, and

FIG. 7 shows a device according to the present invention.

### DESCRIPTION OF EMBODIMENTS

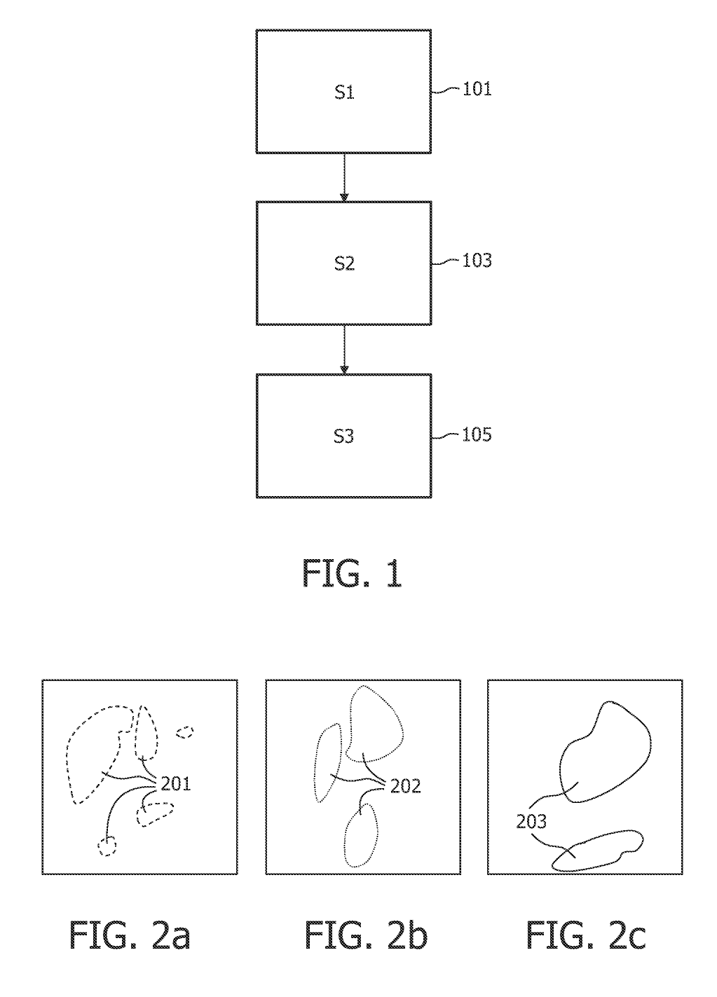

FIG. 1 shows a flowchart of a method according to the present invention of fusing multiple binary cluster maps representing characteristic information into a single cluster map in accordance to a combination rule defined by a combination algorithm. In an embodiment, the combination rule is defined by the recursive formula:

R_{N,N-1, . . . , 1}R_{N}+(1−R_{N})R_{N-1, . . . , 1}

where R_{N} is the reliability factor for binary cluster map N, R_{N-1} for cluster map N−1 etc. FIGS. 2a-c shows an example of three binary cluster maps 201-203, wherein in this particular case the characteristic information is the same, but obtained with different approaches. As an example, the characteristic information could be a hypoxia related parameter which can be measured by MR-BOLD measurement, by pharmacokinetic analysis of suitable PET-images or by MR-CEST measurement. As shown in FIG. 2 the resulting cluster map differ from each other.

In more general terms, each cluster map represents a parameter that in the end serves to answer a certain biological/clinical/medical question. The parameters do not necessary have to be exactly the same, and can in many cases be different. For example: a clinical application could be finding malign lung nodules. For this task, a CT scan and additionally a PET scan would typically be performed. In each of the scans, the regions that possibly correspond to cancerous tissues are delineated. For the CT, this is based on density changes and anatomical information, for the PET this is based on metabolic information. In this particular case the characteristic information are in principle different, but serve the same object, i.e. to find out where regions of cancerous tissue are. One binary map therefore represents cancer based on the anatomical parameters from CT and one binary map represents cancer based on metabolic rates from PET. The idea is accordingly to combine both information sources and present one map to the clinician.

Referring to FIG. 1, each binary cluster map 201-203 shown in FIG. 2 must initially be assigned with a reliability factor (S1) 101. This may be performed manually by a user, e.g. a doctor, technician, based on the user's experience. As an example, the user might assign the reliability factor value R1=0.6 for the first map 201 in FIG. 2, R2=0.8 for the second cluster map 202, and R3=0.4 for the third cluster map 203, where 0<R<1 with 1 as the highest reliability. Thereby, the user has evaluated the reliability of the maps 201-203, i.e. according to the user's opinion the second binary cluster map 202 is the most reliable one. The assigned reliability could just as well be done automatically. This could e.g. comprise comparing the binary maps with pre-stored binary maps obtained with the same analysis method, where e.g. statistical evaluation determines the quality of the binary maps, or it could comprise a library of analysis methods and modalities with associated “average” reliability values, e.g. Lung nodule scan with CT: R=0.8, Lung nodule scan with FDG PET: R=0.85, etc.

The assigned reliability factors are then utilized as input parameters for determining the reliability vector for the single cluster map (S2) 103, wherein the reliability vector comprises reliability factor elements. Each element is associated to a certain cluster map area in the single cluster map and indicates the reliability of the cluster map area. This will be discussed in more details later.

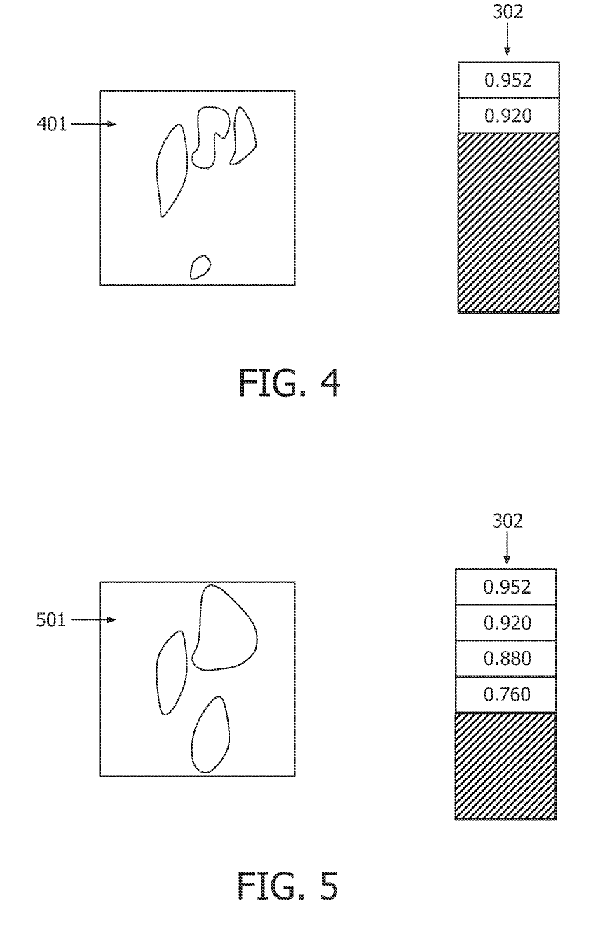

In an embodiment, threshold value is assigned for the reliability vector (S3) 105 and is utilized as an input parameter for an updated single cluster map (S4) 107. This is depicted in FIGS. 4-6 that show three different threshold levels.

Referring to the example above, assuming N=3 (e.g. the three binary cluster maps in FIG. 2a-c) where R1=0.6, R2=0.8 and R3=0.4, it follows that R_{N,N-1, . . . , 1}=R_{N}+(1−R_{N})R_{N-1, . . . , 1} becomes:
R_{3,2,1}=R₃+(1−R₃)R_{2,1}=R₃+(1−R₃)(R₂+(1−R₂)R₁)=0.952
R_{2,1}=R₂+(1−R₂)R₁=0.920
R_{1,3}=R₁+(1−R₁)R₃=0.76
R_{2,3} =R₂+(1−R₂)R₃=0.88
R₃=0.4
R₂=0.8
R₁=0.6.

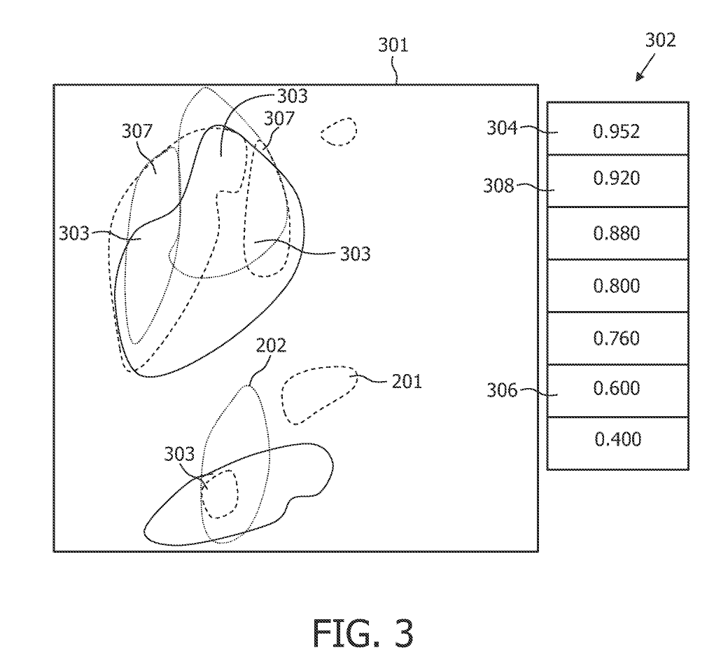

The output of the combination rule is a reliability vector given by R=[0.952; 0.920; 0.880; 0.760; 0.800; 0.600; 0.400], where the first four vector elements are fused reliabilities elements (two or more portions form the clusters in the cluster maps 201-203 overlap) and the last three elements are the initial reliability elements (no overlap of the cluster maps). FIG. 3 shows a single combined cluster map 301 obtained from the binary cluster maps in FIG. 2a-c when R1=0.6 (for FIG. 2a), R2=0.8 (for FIG. 2b) and R3=0.4 (for FIG. 2c) are assigned as the reliability factor values for the binary cluster maps 201-203. In FIG. 3, area 303 is defined by the boundaries from three binary cluster map areas from FIG. 2a-c, i.e. these areas are defined by the overlap portions from the three cluster maps in FIG. 2. The reliability factor value 304 in the reliability vector 302 is given by the value 0.952. In a preferred embodiment, this reliability factor value is illustrated so that it can easily be linked to area 303. One way of doing so is to use color information. If e.g. the initial cluster maps in FIG. 2a-c are illustrated by different colors, e.g. map 201 is illustrated by red color, map 202 with a blue color and map 203 with yellow color, the single cluster map will comprise partly the combination of these colors and partly the original colors where no overlap occurs. Accordingly, the area 303 in FIG. 3 will have a certain grey color (based on the sum of the three colors) and therefore the reliability factor value 304 will be displayed or indicated in any way by the same color. Area 201 on the other hand in FIG. 3 is directly depicted from FIG. 2a and could therefore be shown as red area. The corresponding vector element 306 having the value 0.6 is shown as red color. In an embodiment, the areas consisting of multiple original areas (overlapped areas) could be colored with stripes of all associated original colors, i.e. area 303 would accordingly be colored in alternating stripes of red, blue and yellow.

Accordingly, by indicating the single cluster map in FIG. 3 with e.g. such color information, the different areas can be interpreted with the reliability factor values in the reliability vector 302. In this example, the highest reliability values in the vector 302 are those where the cluster maps 201-203 overlap. This is e.g. said area 303 and area 307 that is based on the combination of cluster map 201 and 202 from FIG. 2, where the corresponding vector element 308 is 0.920 (and is displayed with the same color, which would be purple).

In another embodiment, the single cluster map could be presented so that e.g. “green” means that all three initial maps match each other, “orange” means, that only two initial maps match, and “red” means that only one initial map contributes in this region.

In an embodiment, it would also be possible to display the fused map with a continuous color map without threshold.

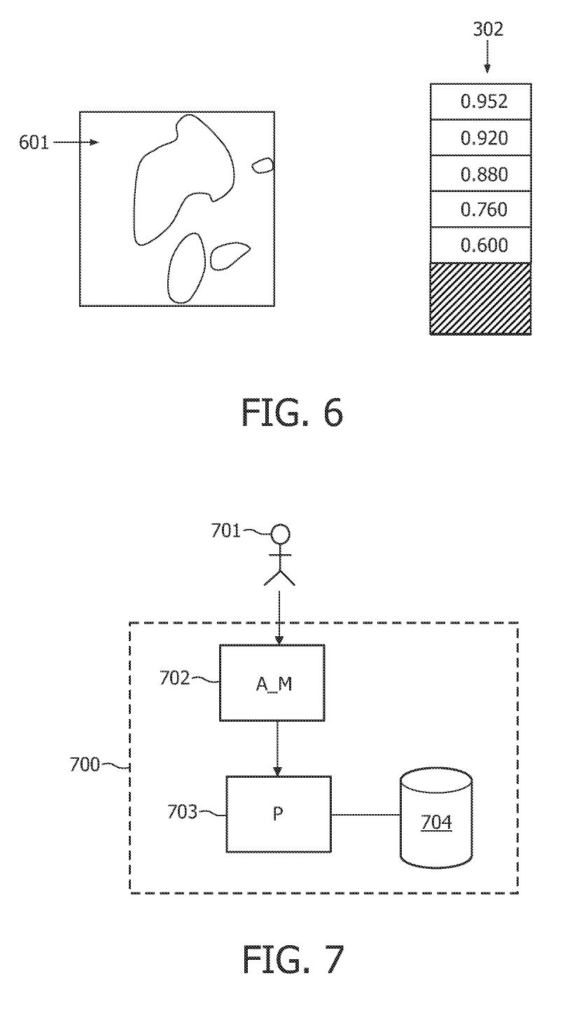

FIGS. 4-6 depict an embodiment where a threshold value is assigned for the reliability vector 302, wherein the threshold value is utilized as an input parameter for an updated single cluster map. In FIG. 4 the threshold value is assigned to be 0.88. This means that the updated cluster map 401 will comprise only those clusters that have reliability above 0.88, i.e. those areas having reliability 0.920 and 0.956. This assignment could be performed manually by a physician or any other user, e.g. technician. The technician could evaluate that the cluster map 401 is not acceptable and therefore reduce the threshold value down to 0.600 that results in the single cluster map 501 shown in FIG. 5, or even down to 0.400 resulting in the updated single cluster map 601 in FIG. 6.

Accordingly, the method provides means to interactively to change the threshold value.

In an embodiment, the various threshold values could be changed automatically. As an example, typical threshold values could automatically be selected and the resulting single cluster maps could be displayed to the physician. In continuation of that, the technician could subsequently improve the single cluster map manually.

FIG. 7 shows a device 700 according to the present invention for combining multiple binary cluster maps into a combined cluster map in accordance to a pre-defined combination rule where each respective binary cluster map includes characteristic information and the combined cluster map includes a sum of the characteristic information. The device 700 comprises an assigning unit (A_M) 702 for assigning each respective binary cluster map with a reliability factor and a processor (P) 703 for utilizing the reliability factor as input parameters for the combination rule for combining the multiple binary cluster maps into the combined cluster map. In an embodiment, the assigning unit comprises an input unit for enabling a manual input by a user 701 (e.g. physician, technician). This could e.g. comprise a keyboard, a mouse, a touch screen function, a speech recognition system and the like, for receiving the instructions form the user 701. The unit for assigning could further include a software that is adapted to process each respective binary cluster map and based on the processing evaluate the reliability factors for the binary cluster maps.

Certain specific details of the disclosed embodiment are set forth for purposes of explanation rather than limitation, so as to provide a clear and thorough understanding of the present invention. However, it should be understood by those skilled in this art, that the present invention might be practiced in other embodiments that do not conform exactly to the details set forth herein, without departing significantly from the spirit and scope of this invention. Further, in this context, and for the purposes of brevity and clarity, detailed descriptions of well-known apparatuses, circuits and methodologies have been omitted so as to avoid unnecessary detail and possible confusion.

Reference signs are included in the claims, however the inclusion of the reference signs is only for clarity reasons and should not be construed as limiting the scope of the claims.

1. A method of combining multiple binary cluster maps (201-203) into a single cluster map (301), where each respective binary cluster map includes characteristic information and the single cluster map represents a combination of the characteristic information, the method comprising:
assigning (101) each respective binary cluster map (201-203) with a reliability factor for indicating the reliability of each respective binary cluster map,
utilizing (103) the reliability factors as input parameters for a pre-defined combination rule for determining a reliability vector (302) for the single cluster map, wherein the reliability vector comprises reliability factor elements (304, 306, 308), where each respective reliability factor element is associated to a certain cluster map area (303, 307, 201) in the single cluster map and indicates the reliability of the cluster map area.

2. A method according to claim 1, wherein the method further comprises:
assigning (105) a threshold value for the reliability vector (302), and
utilizing (107) the assigned threshold value as an input parameter for an updated single cluster map (401, 501, 601).

3. A method according to claim 1, wherein the step of assigning each respective binary cluster map (201-203) with a reliability factor is performed manually.

4. A method according to claim 1, wherein the step of assigning each respective binary cluster map (201-203) with a reliability factor is performed automatically by comparing the multiple binary clusters with reference binary clusters having assigned reliability factors.

5. A method according to claim 2, wherein the step of assigning a threshold value for the reliability factor elements (304, 306, 308) is performed manually.

6. A method according to claim 2, wherein the step of assigning a threshold value for the reliability factor elements (304, 306, 308) is performed automatically by comparing the multiple binary clusters with reference binary clusters having assigned threshold values.

7. A method according to claim 1, wherein the pre-defined combination rule is given by the equation:
R_{N,N-1, . . . , 1}R_{N}+(1−R_{N})R_{N-1, . . . , 1}
with Rj as the reliability factor for binary cluster map j=1 . . . N, where N is the total number of initial binary cluster maps.

8. A method according to claim 2, wherein different color information is associated to each respective binary cluster map (201-203), and wherein the reliability vector (302) is displayed simultaneously with the combined cluster map (301) with corresponding color information such that each vector element (304, 306, 308) associated with a given combined cluster map portion is displayed with the same color information.

9. A computer program product for instructing a processing unit to execute the method step of claim 1 when the product is run on a computer.

10. A device (700) adapted to combine multiple binary cluster maps (201-203) into a single cluster map (301), where each respective binary cluster map includes characteristic information and the single cluster map represents a combination of the characteristic information, comprising:
assigning unit (702) for assigning each respective binary cluster map (201-203) with a reliability factor for indicating the reliability of each respective binary cluster map, and
a processor (703) for utilizing the reliability factors as input parameters for a pre-defined combination rule for determining a reliability vector (302) for the single cluster map, wherein the reliability vector comprises reliability factor elements (304, 306, 308), where each respective reliability factor element is associated to a certain cluster map area (303, 307, 201) in the single cluster map and indicates the reliability of the cluster map area.

11. A device according to claim 10, wherein the assigning unit (702) for assigning comprises an input unit adapted to receive a manual input from a user (701) or an algorithm adapted to automatically evaluate the reliability factor assigned to each respective binary cluster map.

12. A device according to claim 10, being comprised in a medical workstation or medical imaging system.
